(19) United States
(12) Patent Application Publication
(10) Pub. No.: US 2024/0429421 A1
(43) Pub. Date: Dec. 26, 2024

(54) High Temperature Proton Exchange Membrane and Direct Cell Deposition and Manufacturing Process

(71) Applicant: ZeroAvia Ltd., Gloucestershire (GB)

(72) Inventors: Sergei SHUBENKOV, Gloucestershire (GB); Victor BELOUSOV, Gloucestershire (GB); Aleksandar Vasilev TODOROV, Gloucestershire (GB)

(73) Assignee: ZeroAvia Ltd., Gloucestershire (GB)

(21) Appl. No.: 18/212,492

(22) Filed: Jun. 21, 2023

(51) Int. Cl. H01M 8/2425; H01M 4/88; H01M 8/1004

(52) U.S. Cl. CPC H01M 8/2425; H01M 4/8896; H01M 8/1004; H01M 2008/1095

(57) ABSTRACT

The invention of the current application is directed to a high temperature proton exchange membrane (HTPEM) fuel cell and manufacturing process thereof. The fuel cell includes at least one bipolar plate (BPP) layer, at least one gas diffusion layer (GDL) at least one catalyst layer, and a membrane layer. Additionally, the invention of the current application is directed to a manufacturing process which joins each layer of a (HTPEM) fuel cell in a stacked formation wherein in some embodiments the GDL, catalyst layers, and a membrane layer are pre-casts into a membrane electrode assembly MEA. The resulting (HTPEM) fuel cell has a lower passive area without the need for bulky and heavy gaskets and subgaskets.

### BACKGROUND OF THE INVENTION

High Temperature Proton Exchange Membrane (HTPEM) fuel cells are prone to defects, and labor intensive and expensive to manufacture. There is a long-felt need for HTPEM fuel cells that can be manufactured using high volume manufacturing processes to drive down cost in order to enable scale up of HTPEM technology. Specifically, existing methods of scaling membrane electrode assemblies (MEAs) to the bipolar plates (BPPs) result in poor sealing between and inside HTPEM cells, and bulky (heavy) gasket/subgasket designs, resulting in significant portions of passive area.

The passive area in a fuel cell does not participate in chemical reactions. While passive area includes components that perform a host of necessary functions in the cell (mechanical support, vibration resistance, chemical stability, electrical insulation and sealing to prevent leaks of reactant gas and phosphoric acid), having a large ratio of passive area to active area brings down performance by adding weight and thus limiting scalability by decreasing specific power, which is the power produced (i.e. by an electrochemical device) per unit weight. For example, sealing between cell components is traditionally addressed by gaskets, subgaskets, and spacers. These components are most often pre-manufactured to be applied separately, and contribute to a significant region of passive area and weight.

To solve this problem traditionally, one skilled in the art may consider reducing the passive area by combining components or tuning materials (as in JP2010050098, “Fuel cell electrode using triazole modified polymer, and membrane electrode composite”) to perform multiple functions within the same space. In one case, subgaskets—which provide a seal between the membrane and GDL within the MEA—have been integrated into membranes by material optimization (U.S. Pat. No. 10,446,868B2, “Fuel cell subassemblies incorporating subgasketed thrifted membranes”). Subgaskets are traditionally polymeric; they are thus fairly compatible to bond with the polymeric membrane. However, the larger portion of passive area—and more difficult to reduce by integration—comes from the gaskets, which function to provide a seal between the dissimilar polymeric MEA and traditionally metallic BPP.

Some approaches at improved sealing include manufacturing methods such as direct membrane deposition (Xue et al. entitled “Reinforced high-performance membrane electrode assembly for proton exchange membrane fuel cell prepared via direct membrane deposition”. Journal of Tsinghua University Science and Technology Vol. 61, Issue 10, pages 1039-1045, 2021) and direct electrostatic deposition (Liu, H.; Tian, R.; Liu, C.; Zhang, J.; Tian, M.; Ning, X.; Hu, X.; Wang, H. Precise Control of the Preparation of Proton Exchange Membranes via Direct Electrostatic Deposition. Polymers 2022). These have previously been used for achieving well-bonded components and simplified MEA manufacturing in Low Temperature Proton Exchange Membrane (LTPEM) fuel cells, which are primarily dry systems given their solid thin film Nafion electrolyte. However, the prior art direct deposition methods cannot be readily transferred to HTPEM fuel cells since these wet acidic systems have phosphoric acid embedded into the electrolyte and thus are incompatible with existing direct deposition recipes. The stringent conditions of HTPEM operation also make alternatives such as hot pressed perimeter sealants (DE102013014083, “Process for producing a membrane-electrode assembly with circumferential seal and membrane-electrode assembly”) unpreferred due to the low efficiency (long time spent for heat transfer) and manufacturing tolerance i.e. too much pressure leads to overcompression/membrane thinning/potential fracture, whereas too little pressure leads to insufficient bonding.

There is therefore a desire for a manufacturing process where chemically compatible HTPEM layers, for example, BPP, membrane, gas diffusion layer (GDL), and a catalyst layer, are directly deposited sequentially to form an integrated HTPEM cell with a well-sealed membrane to the BPP without the use of gaskets.

Even in view of the teachings above, their remains a desire for a manufacturing process where chemically compatible HTPEM layers, for example, BPP, membrane, gas diffusion layer (GDL), and a catalyst layer, are directly deposited sequentially to form an integrated HTPEM cell with a well-scaled membrane to the BPP without the use of gaskets which is provided by this application. Components such as gaskets, subgaskets, and spacers traditionally serve to enhance scaling and thus prevent leaks of reactant gas and phosphoric acid, as well as provide vibration resistance, chemical stability, and electrical insulation, Part of the passive area is also from the excess material needed to manufacture these components to be mechanically capable of free-standing. Thus, the components are generally necessary in the prior art.

### SUMMARY OF THE INVENTION

The current application provides such a manufacturing process where chemically compatible HTPEM layers, for example, BPP, membrane, GDL, and a catalyst layer, are directly deposited sequentially to form an integrated HTPEM cell with a well-sealed membrane to the BPP without the use of gaskets. This manufacturing process lowers manufacturing cost and time by using less equipment, less processing steps, and more reproducible manufacturing that minimizes human contact & defects. It also eliminates manufacturing challenges in step-wise manual placement and hot-pressing or acid boiling of delicate components and composite structures.

The manufacturing process also simplifies design and increases specific power (lightweighting) from decreased passive area of gaskets/subgaskets. The active area (i.e. membrane, catalytic area, GDL, and the cooling/reactant channels of the BPP) is where the chemical reactions take place whereas the passive area (gaskets, perimeter and gas collector subgaskets, spacers, BPP base plates, and metallic end plates) functions primarily to provide structural integrity to the cell and does not contribute to chemical reactions. Increasing the ratio of active to passive area increases the cell specific power which is the energy stored in a battery or fuel cell per unit weight. For example, in a typical prior art fuel cell with a cell of active area X, there is 0.6X (60%) passive area from structural and sealing components that creates unnecessary additional weight and thus lowers the cell specific power. With direct cell deposition (DCD) of the current application, there can be a substantial comparative reduction in passive area by, for example, 50% to 0.3X which, after accounting for the Balance of Plant, increases the cell specific cell power by 20-30%. In some embodiments, no more than 10% of the total area of the HTPEM is passive. In some embodiments, no more than 15% of the total area of the HTPEM is passive. In some embodiments, no more than 20% of the total area of the HTPEM is passive. In some embodiments, no more than 25% of the total area of the HTPEM is passive. In some embodiments, no more than 30% of the total area of the HTPEM is passive. In some embodiments, no more than 35% of the total area of the HTPEM is passive. In some embodiments, no more than 40% of the total area of the HTPEM is passive. In some embodiments, no more than 45% of the total area of the HTPEM is passive. In some embodiments, no more than 50% of the total area of the HTPEM is passive.

Additionally, increased interfacial contact of the membrane with the catalytic layer leads to less losses defined by lower ionic and charge transfer resistances. This results in higher performance measured through higher specific cell power. Depending on the individual membrane performance (i.e. from level of ionomer-doping), this increase can be between 5-20%.

This is particularly advantageous in aviation where, for example, weight reduction has several important benefits including increased payload, range, and speed, as well as reduced fuel consumption. For example, in an embodiment of this manufacturing process where the specific cell power increases a total of 50% (30% from mass reduction, 20% from increased interfacial contact), the specific power would have increased ˜35% at the stack-level and ˜20% at the system-level, accounting for Balance of Plant. If the system started off as 1 MW (10⁶ W) power with a specific cell power of 2 kW/kg (2*10³ W/kg) and specific system power of 0.6 kW/kg, the initial payload of the aircraft—the weight of fuel, passengers, or equipment with which it can fly—would be (1*10⁶ W)/(0.6*10³ W/kg)=6*10³ kg=6000 kg. In comparison, incorporating the manufacturing method in this invention could increase the specific stack power to about 0.75 kW/kg and thus the payload to 7500 kg., which is 25%.

Unlike the previous manufacturing process of the art, the manufacturing process described in the current application no longer relies on accurate alignment of a membrane with GDLs, compression fixturing, slow stepwise processes, and pre-cast PEM materials (membrane foil). This enables lower cost, less manufacturing time, and greater reproducibility.

In some embodiments, the current application chemically bonds all of the PEM fuel cell layers, including bipolar plates, through direct cell deposition (DCD). The DCD manufacturing method is not only for being able to bond/prepare insitu the parts of the MEA together, e.g., membrane, GDL, catalyst, subgaskets, but also changing the overall approach to be able to bond the polymer MEA to a composite/polymer/coated BPP by joining the components before they polymerize and become solid phase.

In the current application, in-situ manufacturing refers to manufacture the cell applying layer by layer using one and the same equipment. Some advantages of in situ manufacturing are optimization of adhesion. That is, if e.g., membrane polymerization takes place when the cell “sandwich” is fully assembled, the membrane chemically bonds both with the catalytic layers and BPP. It is also conceded that a pre-cast MEA can be used when the chemistry, thickness, and stability are optimized. Both embodiments still implement the core idea of BPP-MEA bonding by a streamlined manufacturing process and enabling materials.

With DCD, enabled embodiment implementation are, for example, 1) preparing all components in-situ or 2) chemically polymerize ‘together’ with the catalytic layer. In some embodiments, two catalytic layers are used with the first one applied on the GDL, then the membrane is applied over the first catalytic layer, then another catalytic layer is applied on top of the membrane, then the second GDL is put on, and finally the second part of the BPP is applied. Moreover, some embodiments do not even apply the catalytic layer on top of the second GDL. In some embodiments, it is important that membrane polymerization takes place when the “sandwich” is fully assembled. This allows the membrane to bond with both catalytic layers and with both parts of the BPP.

Additionally, it is noted that forming a gas diffusion electrode GDE separately is not a feature of many embodiments herein, however, a GDE may be formed at the beginning of the process simply because the 1st catalytic layer is applied to the 1st GDL that is applied to the 1st BPP. Depending on the embodiment, the membrane can be either directly deposited or adhered (if pre-cast) onto this catalytic layer followed by the 2nd catalytic layer and then the 2nd GDL.

In some embodiments, the DCD manufacturing process follows the following steps preferably in the following sequence:
1. BPP is stamped/patterned;
2. The first layer of pre-formed GDL is rolled on to the lower BPP component;
3. The catalytic layer is applied onto the GDL;
4. The membrane is applied to the BPP-GDL substrate by doctor blade, screen printing; roll-to-roll, or other colloidal processing methods;
5. The second catalytic layer is applied on the membrane;
6. The second layer of pre-formed GDL is rolled onto the second catalytic layer;
7. The upper BPP component is applied on top of the second GDL layer;
8. The upper and lower BPP components are bonded to the membrane, because the membrane is extended over the GDL perimeter.
   The manufacturing sequence begins with the BPP, which can be stamped into form and made of a polymeric matrix or a metal-composite material. In many embodiments, the method of BPP formation is not critical. However, stamping is the most cost-effective method to date and can be used in many embodiments herein. Additionally, with the prior art, stamped BPP requires more area to be reserved for gasketing with stamped BPPs (vs molded, machined, or injected BPPs). Some embodiments herein therefore offer even a greater benefit with stamped BPP. In case of stamped BPPs polymeric composite coatings may be used. In case of molded metal-composite BPPs similar polymeric materials may be used. In both cases, the presence of a polymeric material on the BPP surface enables bonding the membrane directly to BPP without gaskets.

Applicants hereby incorporate by reference the disclosure of GB patent application number 2303807.8. In some embodiments, this polymeric matrix or a metal-composite material is coated. With regard to this coating, applicants hereby incorporate by reference GB patent application number 2301023.4. The coating can be patterned to either totally or partially replace Kapton gaskets traditionally used for sealing. Sealing spaces are patterned onto the BPP within interconnected layers in the stack to minimize passive area bonding contact and wetting of membrane material, and prevent fuel crossover where gaskets would have been. In some embodiments, the sealing spaces are positioned where the gaskets would have needed to be but since the tailored BPP is compatible with the MEA by the combination of sol-gel+polymer/composite/coated BPP, spaces are now only needed for the gas collector.

In some embodiments, the perimeter gasket can be replaced as a sealing space directly patterned onto the membrane or BPP while the gas collector gasket is made separately and adhered to the BPP base by pressure and glue. In other embodiments, both gasket types can be replaced by sealing spaces or mechanically supporting hard stops. In some embodiments, BPP features are added before deposition to the MEA when BPP is being stamped/coated. The hard stops function as a perimeter protective area to prevent the membrane from over-compressing on the border regions of contact by providing laterally directed mechanical support (hard-stops). In some embodiments, hard stops are positioned around the perimeter. In some embodiments, hard stops act to optimize the pressure distribution for when the cells are pressed for electrical connection which is distinct than being pressed, that is hot/cold pressed, for manufacturing. In some embodiments, the border is made of the same material as the BPP or as coating.

In some embodiments, the gas diffusion layer (GDL) is pre-formed (woven or non-woven carbon structure) and may optionally be applied by roll-to-roll deposition onto the active area of bi-polar plate to be a substrate for further application of the catalytic layers and membrane.

In some embodiments, the membrane can be either directly synthesized, for example, cast, melted, or solubilized, onto a GDL-BPP substrate using polymeric precursors with incorporated catalysts, dopants, ionomers, and other additives or pre-synthesized in polyphosphoric acid and then catalyst-impregnated. In either case, the membrane should be made thin (10-100 μm, preferably <20 μm) for high power applications such as aviation. The membrane can optionally include integrated subgaskets.

A precast or directly deposited membrane can be chemically bonded or physically adhered to a substrate by various means including, for example, adhesives, solvent bonding, ultrasonic welding, etc. In some embodiments, adhesive polymers can be selected to ensure chemical compatibility to the materials of the membrane, bipolar plate and/or subgaskets. In some embodiments, the adhesives can be pressure sensitive, UV multistage curable, containing organosiloxane cross-linking agents, etc. Preferred adhesives are those which are chemically compatible with the BPP. Additionally, in some embodiments, the materials of the bipolar plate (for example, a polymer binder of composite structure or its protective coating), membrane and subgaskets are also selected with their chemical compatibility with consideration to support a range of the physical and chemical bonding methods listed above. For example, aryl or phenylene based polymers, like polystyrene (PS), polyphenylene sulfide (PPS), or polyethylene terephthalate (PET) may be considered in bonding structure to polybenzimidazole (PBI) membrane, while fluorinated polyolefins, such as polyvinylidene fluoride (PVDF) or polytetrafluoroethylene (PTFE), are not in preferred embodiments.

In some embodiments, a high temperature proton exchange membrane (HTPEM) fuel cell is provide which includes:
at least one bipolar plate (BPP) layer;
and a membrane electrode assembly (MEA) comprising:
   at least one gas diffusion layer (GDL);
   at least one catalyst layer; and
   a membrane,
wherein no more than 50% of the total area of an individual cell of the fuel cell is passive.

In some embodiments, no more than 30% of the total area of the HTPEM is passive.

In some embodiments, the shear strength between the BPP and MEA is no greater than 5 MPa.

In some embodiments, the physical contact of the GDL layer with the catalyst layer is uninterrupted and occurs over the entire adjacent surfaces of the GDL layer and the catalyst layer.

In some embodiments, there are at least two BPP layers, GDL layers, and catalyst layers.

In some embodiments, the layers are arraigned in a stacked configuration where the membrane is positioned in the center of the HTPEM fuel cell,
wherein the catalyst layers are posited above and below the membrane,
wherein the GDL layers are posited above and below the catalyst layers, and
wherein the BPP layers are posited above and below the GDL layers.

In some embodiments, the HTPEM fuel cell additionally includes at least one perimeter gasket positioned at the outer periphery of the stacked layers at an adjacent side of the MEA and deposited directly onto the BPP.

In some embodiments, the BPP layer additionally comprises at least one collector gasket positioned on the outer surface of the BPP layer and wherein the total area occupied by the at least one collector gasket is less than 50% of the outer surface of the BPP layer.

In some embodiments, a DCD manufacturing process is provided with the following steps:
applying a first layer of pre-formed gas diffusion layer (GDL) to a first bipolar plate (BPP) layer;
applying a first catalytic layer to the first GDL;
applying a membrane to the first catalytic layer;
applying a second catalytic layer to the membrane;
applying a second GDL to the second catalytic layer; and
applying a second BPP layer to the second catalytic layer.

In some embodiments, the membrane extends outside the periphery of the catalytic layers and the gas diffusion layers and is bonded to the first and second BPP layers.

In some embodiments, the GDL layers are applied via rolling on the GDL which is adhered with adhesive.

In some embodiments, the membrane and first and second catalytic layers are preformed into a single structure before being applied to the first GDL.

In some embodiments, the membrane and first and second catalytic layer preformed structure is adhered to the first GDL with adhesive.

In some embodiments, a DCD manufacturing process is provided with the following steps:
applying a first bipolar plate (BPP) layer to a membrane electrode assembly (MEA) comprising:
   a first GDL layer;
   a first catalytic layer;
   a membrane layer;
   a second catalytic layer; and a
   second GDL layer.

In some embodiments, the MEA is applied to the BPP layer via polymerization or via doctor blade, screen printing, roll-to-roll, or other colloidal processing methods.

In some embodiments, the BPP layers have been stamped into a upper and lower part and are made of an optionally coated, polymeric matrix or a metal-composite material.

In some embodiments, no more than 50% of the total area of the HTPEM is passive.

In some embodiments, no more than 30% of the total area of the HTPEM is passive.

In some embodiments, the GDL, catalytic layers, and membrane are a pre-casted into MEA via sol gel chemical polymerization.

In some embodiments, all components are prepared in-situ using a single piece of equipment.

### BRIEF DESCRIPTION OF THE DRAWINGS

FIG. 1 is an example of a prior art traditionally manufactured cell, with large passive area around gaskets.

FIG. 2 is an embodiment of the current application showing a simplified design relative to FIG. 1 resulting from direct cell deposition.

FIG. 3 is a side view of a single cell from an embodiment of the current application manufactured by direct cell deposition.

FIG. 4a shows a roll-to-roll GDL deposition followed by 4b or 4c.

FIG. 4b shows catalyst-containing direct membrane deposition onto the GDL-BPP substrate.

FIG. 4c shows roll-to-roll deposition of pre-cast catalyst-impregnated membrane.

### DETAILED DESCRIPTION OF THE DRAWINGS

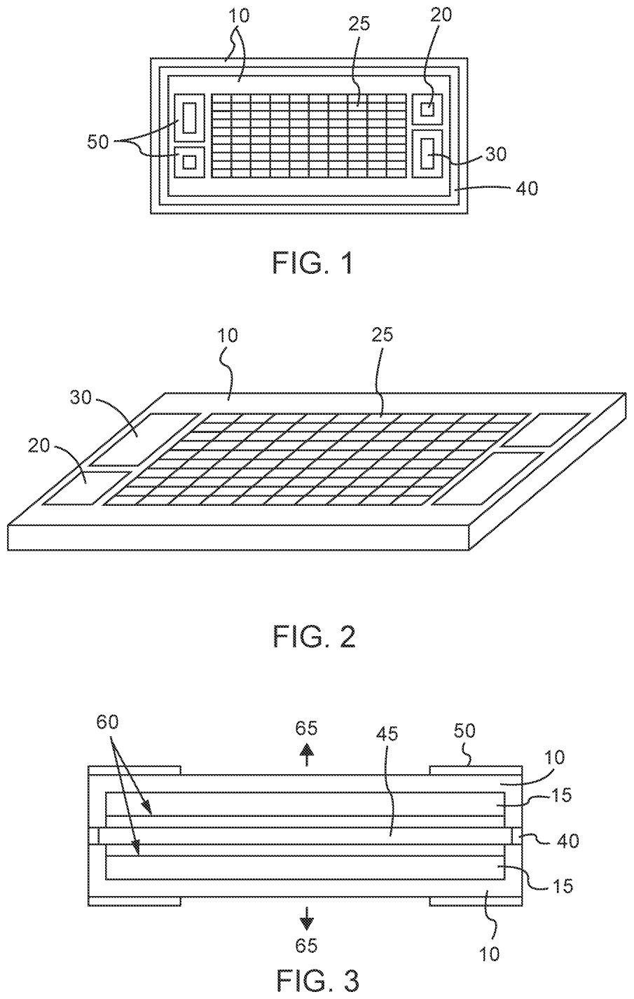

FIG. 1 shows an example of a traditionally manufactured cell. This includes a large passive area around gaskets. Such traditional cells include a BPP base 10 with gas output 20 and gas input 30. A perimeter gasket 40 is provided which mechanically supports hard stops. Gas collector gaskets 50 are also provided, generally on the periphery of the flow channels.

FIG. 2 shows a comparative design to FIG. 1 illustrating the comparatively more efficient design where no gaskets are needed and subgaskets are merely optional. An example of this increased efficiency is shown by the sealing spaces being positioned where the gaskets would have needed to be in the traditionally manufactured cell. In FIG. 2, since the tailored BPP 10 is compatible with the MEA by the combination of sol-gel and polymer/composite/coated BPP 10, spaces are now only needed for the gas input 30 and gas output 20.

FIG. 3 shows a side view of a single cell from an embodiment of the current application manufactured by direct cell deposition. FIG. 3 shows a sandwich like structure with an outer BPP layer 10 which surrounds the inner layers. The BPP layer 10 is followed by a GDL layer 15, a catalytic layer 60, and a membrane layer 45 in the middle. In some embodiments, two BPP layers 10, two GDL layers 15, two catalytic layers 60, and a single membrane middle layer 45 in the middle are arraigned in a stack.

In some embodiments, a perimeter gasket 40 is positioned at the outer peripheries of the membrane layer 45 and between the outer BPP layers 10. In some embodiments, the gas collector gaskets 50 are positioned on the surface of the BPP layers 10 which are opposite the inner layers comprising the GDL layers 15, catalytic layers 60, and membrane middle layer 45. In some embodiments, the gas collector gaskets 50 only occupy the outer edge surfaces of the BPP layers. In some embodiments metal-composite materials for BPP, and cell stack arrangement and allows for optimization of traditionally bulky gasket and subgasket structure for minimizing passive area of the cell.

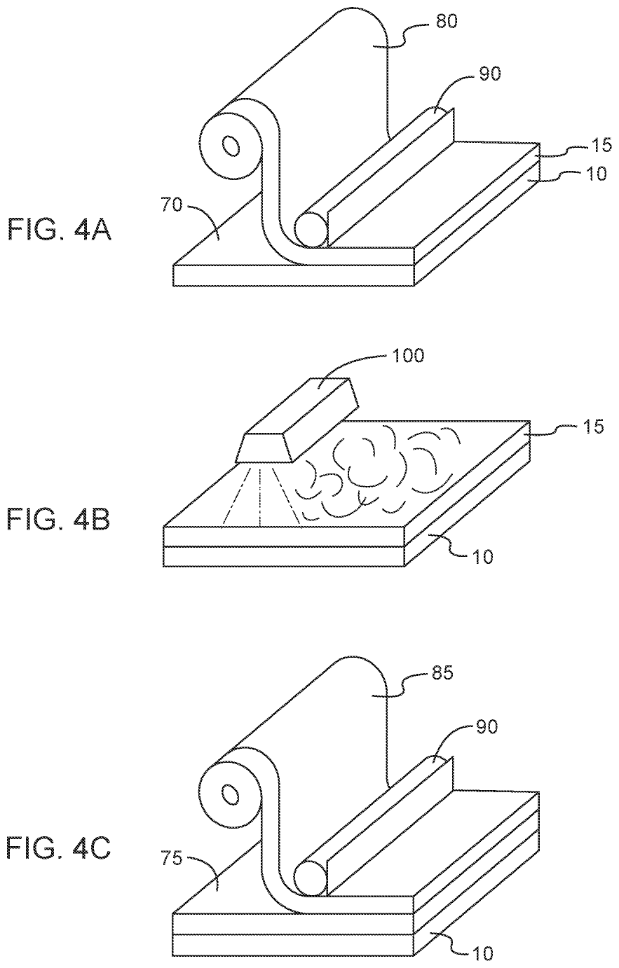

FIG. 4a shows a roll-to-roll GDL deposition followed by 4b or 4c. In step 4a, a pre-cast GDL thin film 80 with a pre-applied adhesive 70 is rolled and cut by a roller and blade 90 onto a BPP layer 10 and cut. The GDL layer 15 is thus positioned on top of and adhered to the BPP layer 10.

FIG. 4b shows catalyst-containing direct membrane deposition onto the GDL-BPP substrate. In step 4b, the catalyst layers 60 and membrane layer 45 are applied on the GDL 15-BPP 10 substrate via, for example, polymerization with a UV light 100. In some embodiments, the full-of-phosphoric acid membrane of the HTPEM requires a ‘wet’ sol gel composition. The FIG. 4B does not comprehensively illustrate all steps enumerated in the sequential step list.

FIG. 4c shows an alternative roll-to-roll deposition embodiment where a pre-cast catalyst-impregnated membrane 85 is rolled on to the GDL 15-BPP 10 substrate in a similar manner to how the GDL 15-BPP 10 substrate was formed using adhesive 75 to adhere the layers together and a roller and blade 90 to apply and cut the appropriate amount of impregnated membrane 85 to fit the preexisting GDL 15-BPP 10 substrate layer.

1. A high temperature proton exchange membrane (HTPEM) fuel cell comprising:
at least one bipolar plate (BPP) layer;
and a membrane electrode assembly (MEA) comprising:
at least one gas diffusion layer (GDL);
at least one catalyst layer; and
a membrane,
wherein no more than 50% of the total area of an individual cell of the fuel cell is passive.

2. The HTPEM fuel cell of claim 1 wherein no more than 30% of the total area of the HTPEM is passive.

3. The HTPEM fuel cell of claim 1 wherein the shear strength between the BPP and MEA is no greater than 5 MPa.

4. The HTPEM fuel cell of claim 1 wherein the physical contact of the GDL layer with the catalyst layer is uninterrupted and occurs over the entire adjacent surfaces of the GDL layer and the catalyst layer.

5. The HTPEM fuel cell of claim 1 wherein there are at least two BPP layers, GDL layers, and catalyst layers.

6. The HTPEM fuel cell of claim 5 wherein the layers are arraigned in a stacked configuration where the membrane is positioned in the center of the HTPEM fuel cell,
wherein the catalyst layers are posited above and below the membrane,
wherein the GDL layers are posited above and below the catalyst layers, and
wherein the BPP layers are posited above and below the GDL layers.

7. The HTPEM fuel cell of claim 6 wherein the HTPEM fuel cell additionally comprises at least one perimeter gasket positioned at the outer periphery of the stacked layers at an adjacent side of the MEA and deposited directly onto the BPP.

8. The HTPEM fuel cell of claim 6 wherein the BPP layer additionally comprises at least one collector gasket positioned on the outer surface of the BPP layer and wherein the total area occupied by the at least one collector gasket is less than 50% of the outer surface of the BPP layer.

9. A DCD manufacturing process comprising:
applying a first layer of pre-formed gas diffusion layer (GDL) to a first bipolar plate (BPP) layer;
applying a first catalytic layer to the first GDL;
applying a membrane to the first catalytic layer;
applying a second catalytic layer to the membrane;
applying a second GDL to the second catalytic layer; and
applying a second BPP layer to the second catalytic layer.

10. The DCD manufacturing process of claim 9 wherein the membrane extends outside the periphery of the catalytic layers and the gas diffusion layers and is bonded to the first and second BPP layers.

11. The DCD manufacturing process of claim 9 wherein the GDL layers are applied via rolling on the GDL which is adhered with adhesive.

12. The DCD manufacturing process of claim 9 wherein the membrane and first and second catalytic layers are preformed into a single structure before being applied to the first GDL.

13. The DCD manufacturing process of claim 12 wherein the membrane and first and second catalytic layer preformed structure is adhered to the first GDL with adhesive.

14. A DCD manufacturing process comprising:
applying a first bipolar plate (BPP) layer to a membrane electrode assembly (MEA) comprising:
a first GDL layer;
a first catalytic layer;
a membrane layer;
a second catalytic layer; and a
second GDL layer.

15. The DCD manufacturing process of claim 14 wherein the MEA is applied to the BPP layer via polymerization or via doctor blade, screen printing, roll-to-roll, or other colloidal processing methods.

16. The DCD manufacturing process of claim 9 wherein the BPP layers have been stamped into a upper and lower part and are made of an optionally coated, polymeric matrix or a metal-composite material.

17. The DCD manufacturing process of claim 9 wherein no more than 50% of the total area of the HTPEM is passive.

18. The DCD manufacturing process of claim 9 wherein no more than 30% of the total area of the HTPEM is passive.

19. The DCD manufacturing process of claim 14 wherein the GDL, catalytic layers, and membrane are a pre-casted into MEA via sol gel chemical polymerization.

20. The DCD manufacturing process of claim 9 wherein all components are prepared in-situ using a single piece of equipment.
